(19) United States
(12) Patent Application Publication
(10) Pub. No.: US 2019/0325501 A1
(43) Pub. Date: Oct. 24, 2019

(54) Meal-Kit Recommendation Engine

(71) Applicant: Relish Labs, LLC, Chicago, IL (US)

(72) Inventors: Erik Jensen, Chicago, IL (US); Andrew Helms, Chicago, IL (US); Dave Giunta, Chicago, IL (US)

(21) Appl. No.: 15/958,502

(22) Filed: Apr. 20, 2018

(51) Int. Cl. G06Q 30/06; G06Q 30/02; G06F 3/0482; G06F 17/30; G06Q 20/12

(52) U.S. Cl. CPC G06Q 30/0631; G06Q 30/0269; G06Q 20/12; G06F 17/30867; G06F 3/0482

(57) ABSTRACT

The disclosed systems and methods may be implemented to provide a distributed meal-kit purchasing system and to automatically update a graphical user interface to display meal-kit recommendations to users of the distributed meal-kit purchasing system. The distributed meal-kit purchasing system may: generate and provide, via an electronic display, a meal-kit menu that advertises meal-kits available for purchase; receive from a user, via an input interface, selections of meal-kits displayed by way of the meal-kit menu; add the selected meal-kits to a digital shopping cart for the user; and facilitate the user's purchase of an order of meal-kits placed in the digital shopping cart. Further, the disclosed systems and methods may recommend to the user meal-kits that he or she is most likely to enjoy.

### TECHNICAL FIELD

The present disclosure generally relates to techniques for providing an interface for selecting meal-kits, and, more particularly, to techniques for automatically updating a graphical user interface to display recommendations and for automatically populating meal-kit selections for users.

### BACKGROUND

While many people appreciate a home-cooked meal, they often lack the time, energy, or skill needed to consistently plan meals, shop for necessary ingredients, and prepare meals. As a result, busy families often turn to restaurants and prepackaged food when making plans for dinner. In recent years, however, an increasingly popular alternative has arisen, enabling these busy families to more consistently enjoy home-cooked meals: meal-kits.

Generally speaking, a meal-kit includes a set of ingredients for a meal and a set of instructions for preparing that meal. Meal-kit companies normally operate on a weekly schedule. In a typical example, a customer selects the meal-kits she wants for a week. The meal-kit company then packs the selected meal-kits into a box and ships the box to the customer. After receiving the box, the customer places the meal-kit ingredients in his or her refrigerator, where he or she can later retrieve them when preparing a meal (with the aid of the corresponding instructions). The meal-kits not only save the customer time and energy that would have been spent planning meals and shopping for groceries; they familiarize the customer with various new foods and meal preparation techniques, expanding the culinary skills of someone who might otherwise avoid cooking entirely.

### SUMMARY

The disclosed systems and methods may be implemented to provide a distributed meal-kit purchasing system and to automatically update a graphical user interface to display meal-kit recommendations to users of the distributed meal-kit purchasing system. The distributed meal-kit purchasing system may: (i) generate and provide, via an electronic display, a meal-kit menu that advertises meal-kits available for purchase; (ii) receive from a user, via an input interface, selections of meal-kits displayed by way of the meal-kit menu; (iii) add the selected meal-kits to a digital shopping cart for the user; and (iv) facilitate the user's purchase of an order of meal-kits placed in the digital shopping cart.

To improve the user's experience, the disclosed systems and methods may recommend to the user meal-kits that he or she is most likely to enjoy. Recommending meal-kits may include: (i) generating taste profiles specific to particular customers; (ii) generating meal profiles specific to particular meal-kits; (iii) calculating personalized meal-scores, unique to a particular customer, for a number of meal-kits; and (iv) generating one or more personalized meal-kit recommendations for the particular customer based on the personalized meal-scores unique to the customer.

Note, this summary has been provided to introduce a selection of concepts further described below in the detailed description. As explained in the detailed description, certain embodiments may include features and advantages not described in this summary, and certain embodiments may omit one or more features and/or advantages described in this summary.

### BRIEF DESCRIPTION OF THE DRAWINGS

Each of the figures described below depicts one or more aspects of the disclosed system(s) and/or method(s), according to an embodiment. The detailed description refers to reference numerals included in the following figures.

FIG. 1A is a block diagram of an example system for recommending meal-kits.

FIG. 1B depicts an example meal-kit menu shown in FIG. 1A.

FIG. 2A is an example screenshot including a window, generated by the system shown in FIG. 1A, displaying a meal-kit menu.

FIG. 2B is an example screenshot including a window, generated by the system shown in FIG. 1A, displaying a recipe page associated with the meal-kit menu depicted in FIG. 2A.

FIG. 3 is a data relationship diagram depicting example data stored in a database shown in FIG. 1A.

FIG. 4 is a flow chart of a method of recommending meal-kits.

FIG. 5 is a flow chart of a method of calculating a personalized meal-score for a particular customer and a particular meal-kit.

### DETAILED DESCRIPTION

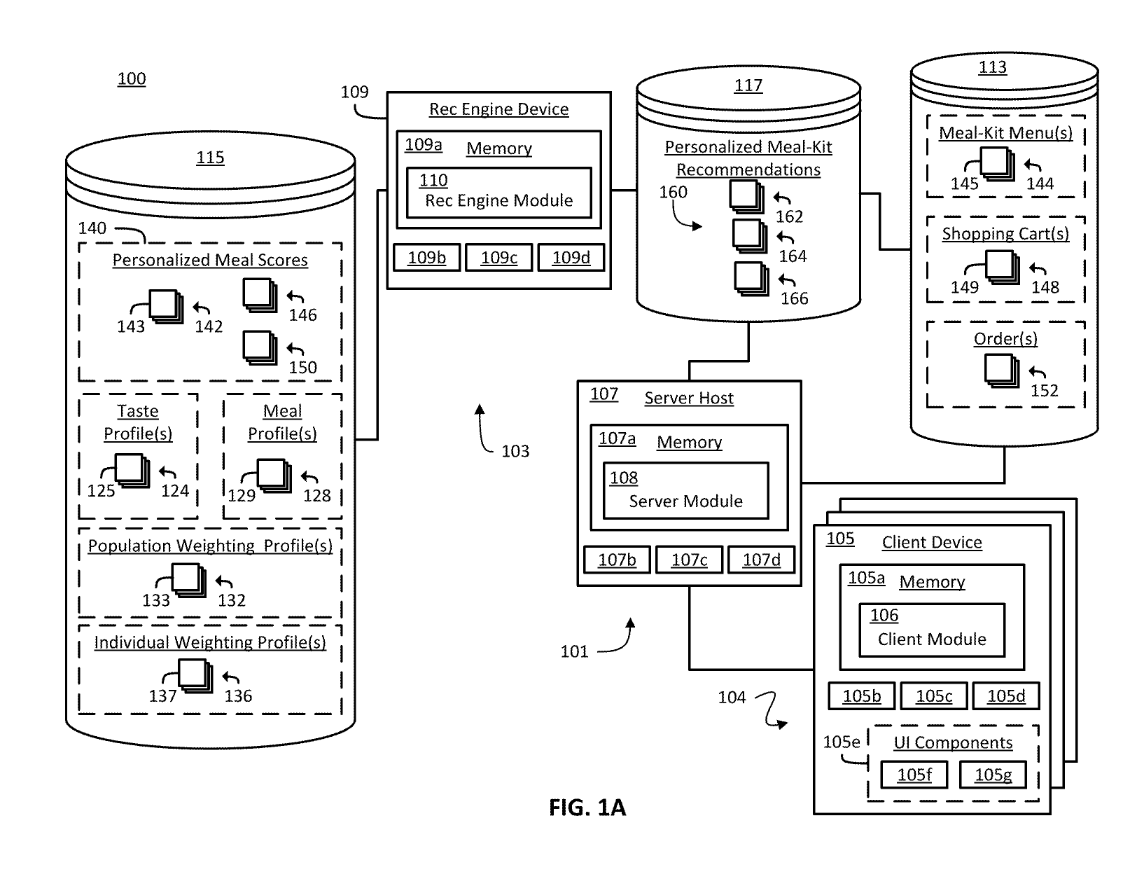

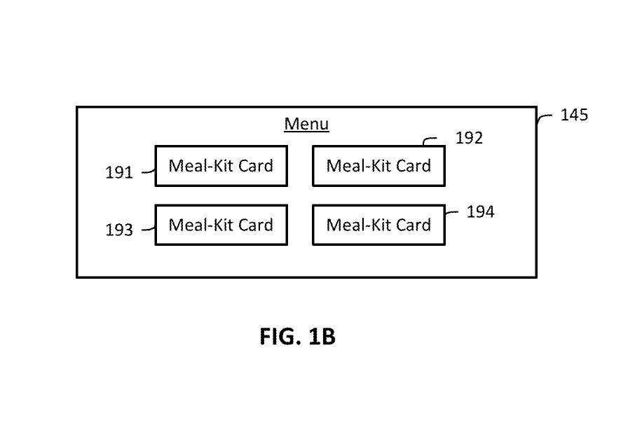

FIG. 1A is a block diagram of an example system 100 that may be implemented to provide a meal-kit purchasing system and to recommend meal-kits for purchase. The system 100 includes a meal-kit purchasing system 101 and a meal-kit recommendation system 103. In example operation, the meal-kit purchasing system 101 provides a meal-kit purchasing interface that a customer can utilize (e.g., via an electronic device such as a personal computer, tablet, or smart phone) to view and purchase meal-kits that will be delivered to the customer. The meal-kit recommendation system 103 generates and stores personalized meal scores and personalized meal-kit recommendations. The personalized meal-kit recommendations may be provided to a user of the meal-kit purchasing system 101 to encourage the user to purchase meal-kits that “match” the user's preferences.

### The Meal-Kit Purchasing System 101

The meal-kit purchasing system 101 includes: one or more client devices 104, including a client device 105 (also referred to as the “clients 104” and the “client 105”); a server host 107 (also referred to as the “server 107”) communicatively connected to the one or more clients 104 via one or more communication links and/or networks; a database 113 communicatively connected to the server 107 via one or more communication links and/or networks; and a database 117 communicatively connected to the server 107 via one or more communication links and/or networks. The database 113 stores one or more meal-kit menus 144, one or more shopping carts 148, and/or one or more orders 152.

### The Meal-Kit Menus 144

Generally speaking, each meal-kit menu 144 is an object or data set representing a meal-kit menu to be displayed via an electronic display for the purpose of advertising one or more meal-kits that can be purchased by a user. Each meal-kit menu 144 may be a collection of “menu elements.” The phrase “menu element” generally refers to any suitable piece of content (e.g., images, text, audio, video) that might be presented (e.g., via a display) to an end-user as part of a meal-kit menu. A given menu element may represent, for example, an advertisement, a message to a consumer, or background colors and borders. In some instances, a menu element may comprise other menu elements (sometimes referred to as sub-elements). An example menu element is a “meal-kit card” advertising a particular meal-kit.

For example, FIG. 1B depicts an example menu 145 (also shown in FIG. 1A) that includes meal-kit cards 191-194. A meal-kit card may include one or more images (e.g., of food in the advertised meal-kit) and/or one or more pieces of text (e.g., the name of the meal-kit and/or a description of the meal-kit).

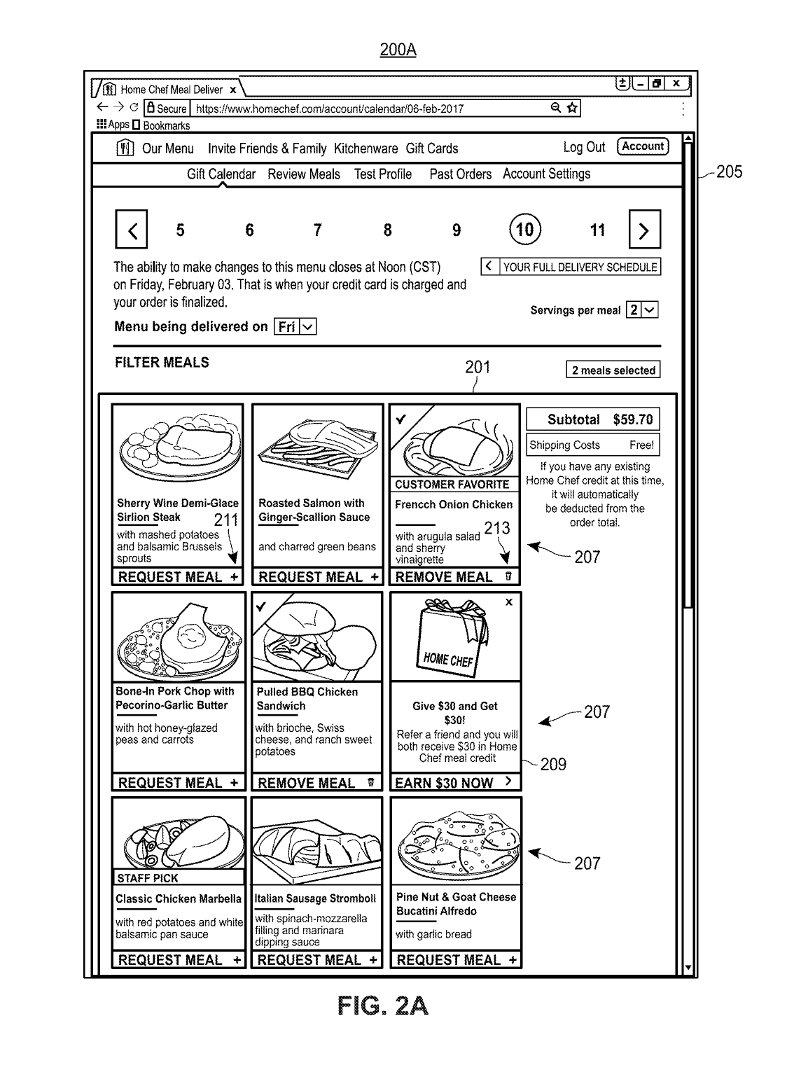

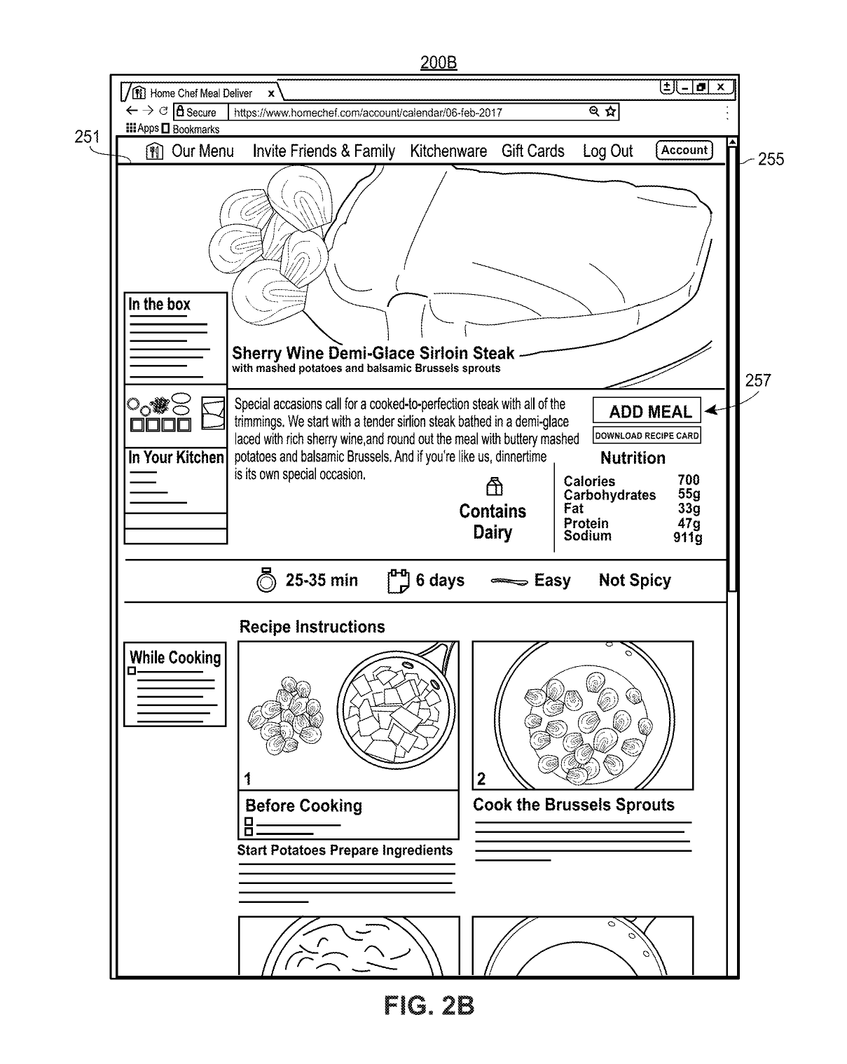

To further illustrate, FIG. 2A is a screenshot 200A of a browser window 205 displaying an example menu 201 that that the client 105 may display after receiving the menu 201 from the server 107. Each of the menus 144 shown in FIG. 1A may be similar to the menu 201. The menu 201 includes meal-kit cards 207 that a user may interact with to view more information about a meal-kit or to order the corresponding meal-kit. As shown, the menu 201 also includes a referral advertisement 209.

As can be seen, each meal-kit card 207 corresponds to a particular meal-kit. For example, the meal-kit cards 207 in the top row correspond to meal-kits titled “Sherry Wine Demi-Glace Sirloin Steak,” “Roasted Salmon with Ginger-Scallion Sauce,” and “French Onion Chicken.” Further, each meal-kit card 207 includes multiple menu elements, such as an image of the meal-kit, a title for the meal-kit, a description for the meal-kit, and a button label “request meal.” In some instances, a meal-kit card 207 may include “meal facts” such as time to prepare, a difficulty level (e.g., easy, medium, hard), and/or a spiciness level. Further, each meal-kit card 207 may include additional or alternative images, like an image of all of the meal-kit ingredients laid out prior to preparation.

In some instances, interacting with a meal-kit card 207 causes the browser window 205 to display a recipe page 221, as shown in FIG. 2B. Like the menu 201 shown in FIG. 2A, the recipe page 221 includes a number of menu elements. For example, the recipe page 221 includes a description of what is included in the meal-kit box, a title, a cost per serving, a list of things a person would need from his or her own kitchen to prepare the meal, a category identifier for the meal-kit (e.g., calorie-conscious, carb-conscious, contains gluten, contains dairy, contains soy, contains shellfish, contains nuts, vegetarian), a button to add the meal-kit to a shopping cart, a button to download a recipe card, the meal-facts described with reference to FIG. 2A, and detailed recipe instructions with corresponding images for each stage of the instructions.

Depending on the embodiment, a recipe page associated with a meal-kit card may include more or fewer menu elements than those included in the recipe page 201. Further, in some instances, the menu 201 may include more or fewer meal-kit cards 207, and/or more or fewer advertisements 209.

Returning to FIG. 1A, the meal kit menus 144 may include current menus as well as future menus (e.g., menus not currently “available,” but scheduled to be released or published at a future date). In some instances, the menus 144 includes menus that have been personalized for particular users based on one or more of the meal-kit recommendations.

### The Shopping Carts 148 and Orders 152

Each shopping cart 148 is an object or data set representing a digital “shopping cart” that includes meal-kit(s) selected by a particular user. In some instances, each shopping cart 148 may be a list or array of unique identifiers (e.g., strings, integers, or object names) for the meal-kit(s) selected by the user.

Each order 152 is an object or data set representing an order placed by a customer. Each order 152 may include a unique identifier for an order, unique identifiers for purchased meal-kit(s), payment information, and/or confirmation information associated with the order, and/or customer identification information.

### The Client 105 and the Server 107

The client 105 is an electronic device including a memory 105a, a processor 105b, an input/output (I/O) interface 105c, and a communication interface 105d, each of which may be communicatively connected to a system bus (not shown). The I/O interface 105c may be communicatively coupled to one or more UI components 105e, including a display 105f and an input component 105g. The display 105f may be any suitable component or device configured to display information in pictorial or visual form (e.g., utilizing LED, LCD, or CRT technology), and may include a screen (which may be touch sensitive in some instances) or projector. The input component 105g may be any suitable component or sensor that can be actuated to provide input to the client 105, and may include a hardware actuator that mechanically actuates to provide input (e.g., a key, a button, etc.) and/or a sensor that actuates by way of detecting changes in an electromagnetic field (e.g., a capacitive or resistive touch sensor, which may be integrated with the display 105f to form a touchscreen).

The memory 105a of the client 105 includes a client module 106 (sometimes referred to as the “module 106”). The module 106 is a set of machine readable instructions (e.g., a software module, application, or routine) that, when executed by the processor 105b, causes the client 105 to communicate with the server 107 and to receive from the server 107 data utilized to provide a graphical user interface (GUI) that displays meal-kits for sale and that a user can interact with to purchase meal-kits. The module 106 may be a dedicated application for meal-kit purchasing or may be an application not dedicated for meal-kit purchasing, such as a web browser.

The server 107 is an electronic device including a memory 107a, a processor 107b, an I/O interface 107c, and a communication interface 107d, each of which may be communicatively connected to a system bus (not shown). The memory 107a of the server 107 includes a server module 108, which is a set of machine readable instructions (e.g., a software module, application, or routine) that, when executed by the processor 107b, causes the server 107 to communicate with, and provide data to, the client 105 so that the client 105 can provide the GUI for purchasing meal-kits.

In example operation, a user of the client 105 causes the client 105 to launch the client module 106 and to initiate a shopping session for viewing and purchasing meal-kits. This may involve the user actuating the input component 105g (e.g., using a mouse or a touch gesture) to select an icon representing the client module 106 (e.g., when the client 106 is a dedicated application) and/or may involve the user navigating to a website associated with the server 107 (e.g., when the client 106 is a browser). To initiate the shopping session, the client 105 may transmit to the server 107 a request to begin the shopping session. The client 105 may transmit a user identifier or ID (e.g., a user name, such as an email address, unique to the user) to the server 107 with the request. The user may provide the user ID and an associated password to log into his or her personal account when utilizing the client 106 and the shopping session. After transmitting the request, the client 105 may receive from the server 107 data enabling the client 105 and the server 107 to establish the shopping session. For example, the server 107 may transmit data enabling the client 105 to display a graphical user interface (GUI) for viewing and purchasing meal-kits. In some instances, the client 105 may transmit to the server 107 a request for a current meal-kit menu. The server 107 may retrieve a current menu 145 from the menus 144 stored at the database 113, and transmit the current menu 145 to the client 105. The menu 145 may include meal-kit cards advertising meal-kits for sale (the menu 145 and example meal-kit cards are described further below with reference to FIG. 1B). The client 105 may display the menu 145 via the display 105f. As later explained, the server 107 or recommendation engine 109 may customize the menu 145 before transmitting it to the client 105 based on one or more personalized meal-kit recommendations and/or personalized meal-kit scores (each of which may be tailored to a taste profile for the user associated with the user ID) that are stored to memory and uniquely associated with the user ID received from the client 105. In some instances, each taste profile may be unique to a customer, reflecting his or her individual tastes. In other instances, users may share taste profiles. For example, a set of taste profiles may exists (e.g., including a “low calorie” profile, a “vegan” profile, a “nut allergy” profile, etc.), and each customer may be assigned a taste profile selected from this set. In such instances, the personalized meal-kit recommendations may be tailored to each of these existing taste profiles, and thus not necessarily unique to each individual customer.

The client 105 may detect, via actuation of the input component 105g, user input representing selection of one or more meal-kits listed in the menu 145 to be added to a shopping cart 149 uniquely associated with the user. In response, the client 105 may transmit to the server 107 the selection of meal-kits to be added to the shopping cart 149. When the user finishes selecting the meal-kits she wants to purchase, she may provide user input to the client 105 indicating that she wants to check-out and finalize her purchase. In some instances, the shopping cart 149 may be auto-populated with a selection of meal-kits corresponding to the meal-kit recommendations. That is, some meal-kits may be added to the shopping cart 149 without requiring that the user manually add the meal-kits. Of course, in such instances the user may remove from the shopping cart 149 any or all of the automatically added meal-kits. In any event, once the customer is satisfied with the meal-kits in her shopping cart, she may provide user input indicating that she wants to checkout and finalize her purchase. The client 105 detects the user input and transmits to the server 107 a request to check out. The client 105 and server 107 then implement a checkout process and the server 107 saves the user's order as an order 153 to the orders 152.

### The Meal-Kit Recommendation System 103

As noted, the meal-kit recommendation system 103 generates and stores personalized meal scores and personalized meal-kit recommendations. The meal-kit recommendation system 103 includes: a recommendation engine device 109 (also referred to herein as the “recommendation engine 109” or “engine 109”) that may be communicatively connected, directly or indirectly, to the server 107 and/or to the client 105 via one or more communication links or networks; a database 115 communicatively connected to the engine 109 via one or more communication links or networks; and the database 117, which is communicatively connected to the engine 109 via one or more communication links or networks.

The database 115 stores one or more taste profiles 124, one or more meal profiles 128, one or more individual weighting profiles 132, one or more population weighting profiles 136, and/or one or more personalized meal scores 140. The database 117 stores one or more meal-kit recommendations 160. In some instances, the meal-kit recommendations 160 may not be stored to the database 117 as being associated with a particular customer. For example, a fixed number of the taste profiles 124 (e.g., ten) may exist, and each customer may be associated to one of these taste profiles. Further, in some instances, the meal-kit recommendations 160 are not stored to non-volatile storage. Rather, the meal-kit recommendations 160 may be generated and provided in real-time as the user is shopping (e.g., meal-scores may be calculated for available meal-kits when a customer initiates a shopping session, and the resulting recommendations may not be stored to non-volatile storage).

### The Taste Profiles 124

Each of the taste profiles 124 is an object or data set representing a particular customer's preferences regarding meal-kit traits (e.g., spiciness, calorie level, difficulty to prepare, etc.). These preferences may be represented by “customer preference variables” (sometimes called “user preference variables” or “preference variables”). Each customer preference variable may be a variable having any suitable number of values (e.g., 1-3, 1-10, 1-100, etc.) to indicate a degree to which a customer has a preference or aversion to a particular meal-kit trait.

In some instances, the customer preference variables included in each of the taste profiles 124 are “customer tags.” For example, the system 100 may include ten potential customer tags, any number of which can be included in one of the taste profiles 124 to identify a corresponding customer's preferences regarding meal-kits. To illustrate, one of the potential customer tags may be a “spicy” customer tag. The existence or non-existence of the “spicy” customer tag in one of the taste profiles 124 indicates whether or not the customer prefers spicy foods. In short, the customer tag may be thought of as a variable having a binary value to indicate a customer's preference, wherein the tag's inclusion or exclusion in one of the taste profiles 124 signifies the variable's value. Customer tags can be utilized in this fashion to indicate a preference (or lack thereof) for any desirable meal-kit trait.

The customer preference variables for a given one of the taste profiles 124 may be set manually or automatically. For example, manual selection may involve a customer interacting with the client 105 to fill out his or her taste profile and identify his or her preferences (e.g., by selecting particular customer tags). Automatic selection may involve the system 100 analyzing a customer's purchase history to identify (i) traits consistently present or overrepresented in purchased meal-kits; and (ii) traits consistently not present or underrepresented in purchased meal-kits.

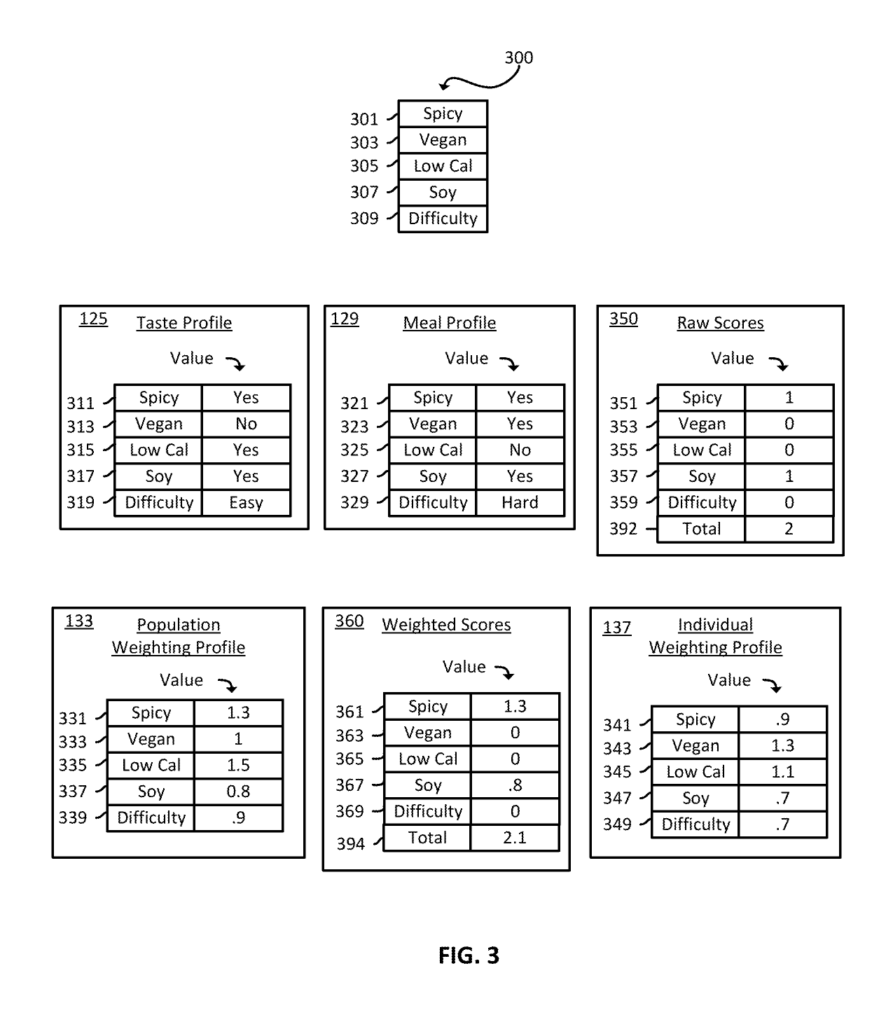

FIG. 3 depicts a set of example customer preference variables 311-319 that may be included in a particular customer's taste profile 125. As shown, the customer preference variables 311-319 correspond to a set of meal-kit traits 301-309 that the system 100 may be configured to track. Each of the customer preference variables 311-319 corresponds to one of the meal-kit traits 300 and has a value representing a preference (or lack thereof) held by the customer associated with the taste profile 124. For example, variable 311 has a value “Yes,” indicating the customer has a preference for spicy meals; variable 313 has a value “No,” indicating the customer does not have a preference for vegan meals; and variable 319 has a value “Easy,” indicating the customer has a preference for easily prepared meals. Each of the customer preference variables may have a value that is binary in nature (i.e., 0/1, yes/no, easy/hard, etc.) or that accords with some other scale (e.g., have a value of 1-5 to indicate a degree to which the customer prefers the particular trait).

### The Meal Profiles 128

Returning to FIG. 1A, each of the meal profiles 128 is an object or data set representing a set of meal-kit traits possessed by a particular meal-kit. The set of meal-kit traits possessed by a particular meal-kit may be represented by “meal-kit descriptor variables” (sometimes called “meal-kit variables”). Like the customer preference variables, each meal-kit descriptor variable may be a variable having any suitable number of values (e.g., 1-3, 1-10, 1-100, etc.) to indicate a degree to which a corresponding meal-kit possesses a particular trait. Generally speaking, the number and nature of potential meal-kit descriptor variables applicable to the meal profiles 128 may correspond to the number and nature of potential customer preference variables applicable to the taste profiles 124. For example, the meal-kit descriptor variables and the customer preference variables may each include: a spiciness variable that can be assigned a value of 1-5; a calories variable that can be assigned a value of 1-3; and a preparation difficulty that can be assigned a value of 1-4.

In some instances, the meal-kit descriptor variables included in each of the meal profiles 128 are “meal tags,” which are similar to the previously described “customer tags.” The existence or non-existence of a particular meal tag in one of the meal profiles 128 indicates whether or not the meal-kit corresponding to that meal profile possesses the trait associated with the particular meal tag. For example, meal profiles for meal-kits including spicy ingredients may each include a “spicy” meal tag, while meal profiles for meal-kits having only non-spicy ingredients may not include the “spicy” meal tag.

The meal-kit descriptor variables for a given one of the meal profiles 128 may be set manually or automatically. For example, manual selection may involve a user manually setting the meal-kit descriptor variables included in a meal profile for a meal-kit when a corresponding meal-kit menu is generated. Automatic selection may involve the system 100 analyzing feedback from customers who have purchased a meal-kit (e.g., the customers may select variable values or tags for meal-kits they have tried). The system 100 may analyze the feedback from multiple customers to identify meal-kit traits consistently selected or not selected for a given meal-kit.

The recommendation engine 109 may generate a “raw score” or “grade” by evaluating a degree to which the user's taste profile and the meal-kit's meal profile match with respect to the values of the customer preference variable values (which may be represented by “customer tags”) and the meal-kit descriptor variable values (which may be represented by “meal tags”). That is, for each of a number of meal-kit traits, the recommendation engine 109 may compare a value of the user's customer preference variable for that meal-kit trait to a value of the meal-kit descriptor variable for the same meal-kit trait. When the customer preference variables and meal-kit descriptor variables are represented by “customer tags” and “meal tags” that may be included in the taste profiles 124 and the meal profiles 128, the recommendation engine 109 may calculate the raw score by evaluating whether the profiles match with respect to the tags. For example, when tags are utilized, if both profiles include tags corresponding to a particular meal-kit trait (e.g., “spicy”), or both do not include the tag, a match exists and a raw score of “1” may be calculated. If one of the profiles includes a tag and the other does not include the tag for the meal-kit trait, a mismatch exists and a raw score of “0” may be calculated (e.g., when a user's taste profile includes a “spicy” customer tag but the meal-kit's meal profile does not include a “spicy” meal tag). Similarly, a raw score may be calculated by evaluating the variables or tags corresponding to the other potential meal-kit traits (e.g., “low calorie,” “vegan,” etc.).

To further illustrate, FIG. 3 depicts a set of example meal-kit descriptor variables 321-329 that may be included in a particular meal-kit's meal profile 129. Like the customer preference variables 311-319, the meal-kit descriptor variables 321-329 correspond to the set of meal-kit traits 301-309 and each has a value representing a degree to which the meal-kit associated with the profile 129 possesses the trait. For example, variable 321 has a value “Yes,” indicating the meal-kit includes spicy ingredients. Notably, the meal profile 129 and the taste profile 125 indicate that the corresponding meal-kit exhibits a trait (i.e., spiciness) that matches the corresponding customer's preference for spicy ingredients (as indicated by the value of variable 311).

As another example, the “Difficulty” variable 329 has a value of “Hard,” indicating the meal-kit corresponding to the meal profile 129 is difficult to prepare. As such, the meal profile 129 and the taste profile 125 indicate that the meal-kit exhibits a trait (i.e., a higher level of difficult to prepare) that does not match the customer's preference for difficulty level (i.e., “Easy,” as indicated by the value of variable 319).

Notably, the taste profile 125 “matches” the meal profile 129 on two of five meal-kit traits: spiciness (as indicated by the values of variables 311 and 321) and soy (as indicated by the values of variables 317 and 327). Thus, in the shown example, when a set of raw scores 350 is calculated by evaluating the taste profile 125 and meal profile 129, the recommendation engine 109 will calculate a raw score 351 of “1” for “Spicy” and a raw score 357 of “1” for “Soy.” Further, the profiles 125 and 129 do not match on the other three traits (as indicated by the values of variables 313 and 323, the values of variables 315 and 325, and the values variables 319 and 329). Thus, in the shown example, the recommendation engine will calculate raw scores 353, 355, and 359 of “0” for “Vegan,” “Low Cal,” and “Difficulty,” respectively. In this example, the recommendation engine 109 may total the raw scores 351-359 to calculate a total raw score 392 of “2,” representing a degree to which the taste profile 125 and the meal profile 129 match. In some instances, each of the personalized meal scores 140 shown in FIG. 1A may be a total raw score such as the score 392. For example, the personalized meal score 143 shown in FIG. 1A may represent the degree to which the taste profile 125 “matches” the meal profile 129 and may be assigned the value of the total raw score 392 (i.e., “2” in this example). In such an example, the taste profile 125 may be compared to other meal profiles to calculate additional total raw scores for the other meal profiles. These total raw score 392 may be compared to the other total raw scores to determine which meal profiles best match or least match the taste profile 125. In the shown example, a total raw score of “5” would represent a perfect match, while a score of “0” would represent a complete mismatch.

In some instances, the recommendation engine 109 may evaluate the degree to which traits in the taste profile 125 match traits in the meal profile 129 to calculate a “raw score” or “grade” for the trait, wherein the raw score represents the degree to which the customer's preference regarding the trait matches the meal-kit in question. In some instances, the raw score is binary. For example, the values of the variables 311 and 321 shown in FIG. 3 indicate a 100% match on the “Spicy” trait (e.g., resulting in a raw score of “1”), while the values of the variables 313 and 323 indicate a 0% match on the “Vegan trait” (e.g., resulting in a raw score of “0”).

Even when the values of the variables 311-319 and 321-329 are non-binary, the raw score may be binary. For example, if the customer preference variables 311-319 and the meal-kit descriptor variables 321-329 have values assigned based on non-binary scales (e.g., 1-10), the recommendation engine 109 may calculate a delta between the taste profile 125 and the meal profile 129 for a particular trait (e.g., the delta between the values of the variables 311 and 321). If the delta is equal to or below a threshold (e.g., 2), the raw score may be “1”; otherwise the raw score may be “0.” As an example, if the variable 311 has a value of 4, the resulting raw score may be a “1” when the value of the variable 321 is any value between 2 and 6 (indicating the meal-kit's level of spiciness matches the customer's preference); while a value of 1 or 7-10 for the variable 321 may result in a raw score of “0” (indicating the meal-kit's level of spiciness does not match the customer's preference).

Further, both the values of the variables 311-319 and 321-329 as well as the raw scores may be non-binary. For example, on a scale of 0-5, variable 311 may have a value of 4 (wherein 5 represents maximum spiciness), indicating a relatively high preference for spicy ingredients. If the value of variable 321 is “2,” the recommendation engine 109 may calculate a delta of 2 for the “Spicy” trait. The delta itself may be used as the raw score, wherein a 0 indicates a perfect match between the customer's preference for a particular trait and the meal-kit. In such an example, when all of the variables 311-319 and 321-329 have been evaluated, the raw scores may be totaled and compared to totaled raw scores for other meal profiles that have been evaluated with respect to the customer profile 125, and the meal profile having the lowest totaled raw score may represent the best match to the taste profile 125. Alternatively, the delta may be subtracted from a “perfect score” (e.g., “5” in this example) to calculate the raw scores, such that higher raw scores and totaled raw scores represent the best match. For example, when the variable 311 has a value of “4” on a 0-5 scale and the variable 321 also has a value of “4,” the delta for the “Spicy” trait would be “0” (delta=4−4=0) and the raw score would be “5” (5−0=5). As a second example, when the variable 311 has a value of “4” and the variable 321 has a value of “1,” the delta for the Spicy trait would be “3” (delta=4−1) and the raw score would be “2” (5−3=2).

As explained below with respect to the weighting profiles 132 and 136, weight factors associated with each meal-kit trait may affect how customer preference variables and meal-kit characteristic variables are evaluated.

### The Population Weighting Profiles 132

Returning to FIG. 1A, each population weighting profile 132 is an object or data set representing a set of weight factors, each of which represents a relative importance of a particular meal-kit trait to a given population. Each weight factor may be a number or percentage intended to be multiplied by a raw score or grade that indicates the extent to which a user's preference for a meal-kit trait is exhibited by a meal-kit.

For example, FIG. 3 depicts a population weighting profile 133 (also shown in FIG. 1A). The weighting profile 133 includes a set of weight factors 331-339 corresponding to the meal-kit traits 300. The “Spicy” and “Low Cal” have the highest value weight factors (“1.3” and “1.5,” respectively), indicating that the population generally places a higher importance on meal-kits matching their preferences on these meal-kit traits than they do on matches for other meal-kit traits. On the other hand, the “Soy” weight factor 337 has the lowest value (i.e., “0.8”), indicating the population places relatively little value on whether or not their preference for soy is exhibited by a meal-kit.

The recommendation engine 109 may apply the weight factors 133 to the raw scores 350 (e.g., via addition or multiplication, depending on the implementation) to develop the weighted scores 360. In particular, the weighted scores 361-369 may be calculated by multiplying the weight factors 331-339 and the respective raw scores 351-359. The weighted scores 361-369 may then be summed to derive a total weighted score 394 of “2.1.” Each of the personalized meal scores 140 shown in FIG. 1A may be a total weighted score such as the score 394.

Because each of the meal-kit traits 300 may have different weight factor values, the total weighted score 394 may be equally or more affected by which matches exists as it is by the number of matches or relative matches that exist. For example, to get a high weighted score indicating that a particular meal profile represents a “good” match for a taste profile, it may be more important that a “match” exists for one or two meal-kit traits with high value weight factors than it is that a “match” exists for a higher number of meal-kit traits with low value weight factors. Of course, the weight factors could be relatively flat (e.g., the weight factors 361-369 could each have a value of “1”), making each meal-kit trait equally valuable when considering whether a taste profile and meal profile match.

As noted (and returning to FIG. 1A), the weight factors in the weighting profiles 132 represent the relative importance of meal-kit traits to a given population. In a typical example, the population of interest is a population of all existing customers (or of all potential customers). In some circumstances, however, the population may be a subset of existing customers or potential customers. For example, population subsets may be divided by any of the following: (i) geographic region (e.g., determined based on a customer's address or based on a known location associated with a network address); (ii) an age provided by the customers; (iii) a gender provided by the customers; (iv) diet preferences provided by the customers; or (v) preferences for different categories of food, such as the region or ethnicity of origin for the food. For example, among a population of customers who have expressed a preference for Chinese food, a profile 132 may include a unique (or relatively unique) set of weight factors revealing the most and least important meal-kit traits for customers within the population of customers who prefer Chinese food. To illustrate, customers preferring Chinese food may place a relatively high degree of importance on the “Spicy” trait.

Each of the weighting profiles 132 may be generated based on observed behavior of the population in question. For example, a weighting profile for the population may be developed by comparing taste profiles of customers to the purchase histories of the customers. For example, for each customer, the recommendation engine 109 may calculate a correlation coefficient indicating a degree to which a preference for a meal-kit trait results in a purchase or repurchase of a meal-kit having that trait. The coefficient may have a value within a range of −1.0 to 1.0, wherein: (i) a coefficient of −1.0 represents a perfect negative correlation (i.e., a preference for the meal-kit trait is strongly correlated to customers not purchasing meal-kits with that trait); (ii) a coefficient of 0 represents no correlation (i.e., a preference for the meal-kit trait is not predictive as to whether a customer purchases meal-kits having that trait); and (iii) a coefficient of 1 represents a perfect positive correlation (i.e., a preference for the meal-kit trait is strongly correlated to a customer purchasing meal-kits exhibiting that trait). The coefficients for each meal-kit trait may be used by the recommendation engine to develop the weight factor values (e.g., for the weight factors 361-369). In some instances, the coefficient values themselves may be used for the weight factor values.

In some instances, the population weighting profiles 132 may additionally or alternatively be meal-specific (e.g., rather than trait-specific). That is, each population weighting profile 132 may include a weight factor for each available meal-kit. For example, it may be known that some meal-kits are more popular than others among a given population. These popular meal-kits may be given a “bonus” when calculating personalized meal scores. For example, if two meal profiles have roughly equal meal scores for a given taste profile (which may correspond to one or more customers), one of the population weighting profiles 132 may be applied to the scores, resulting in the more popular meal-kit being more heavily weighted and thus resulting in a better overall score for the more popular meal-kit.

### The Individual Weighting Profiles 136

Similar to the population weighting profiles 132, each individual weighting profile 136 is an object or data set representing a set of weight factors. However, unlike the weighting profiles 132 (each of which includes weight factors representing a degree of importance a given meal-kit trait has for a population), each of the individual weighting profiles 136 includes weight factors representing a degree of importance a given meal trait has for an individual (e.g., a customer or potential customer). Each weight factor in each of the weighting profiles 136 may be a number or percentage intended to be multiplied by a raw score or grade that indicates the extent to which a user's preference for a meal-kit trait is exhibited by a meal-kit. The weighting profiles 136 may be similar in nature and value as the weighting profiles 132, and may be used in a similar fashion as described above to develop weighted scores. FIG. 3 depicts an example weighting profile 137 that includes weight factors 341-349. In this example, the weighting profile 137 corresponds to the customer associated with the taste profile 125. Thus, when compared to the weighting profile 133, the weighting profile 137 may be considered to include weight factors that more precisely represent the degree of importance the particular customer places on the various meal-kit traits 300.

In some embodiments, the system 100 does not include any individual weighting profiles 136. For example, the system 100 may rely exclusively on the population weighting profile(s) 132 when developing weighted scores. Further, in some embodiments, the system 100 does not include any weighting profiles 132, and may rely exclusively on the individual weighting profile(s) 136 when developing weighting scores.

### The Personalized Meal Scores 140

Each of the personalized meal scores 140 is calculated by the recommendation engine 109 based on an analysis of one of the individual taste profile(s) 124 and one of the meal profile(s) 128. For example, the personalized meal score 143 may be assigned the value of the total raw score 392 or the total weighted score 394 described above with reference to FIG. 3.

The personalized meal scores 140 may include sets of scores 142, 146, and 150, each corresponding to a different customer's taste profile 124 (e.g., the first set of scores 142 may correspond to the taste profile 125 and the second set of scores 146 may correspond to a second taste profile). The analysis may account for the population weighting profile(s) 130 and/or the individual weighting profile(s) 134.

### The Meal-Kit Recommendations 160

The meal-kit recommendations 160 includes one or more sets of meal-kit recommendations 162, 164, and 166, each of which may be generated by the recommendation engine 109 and/or server 107 based on a corresponding set of meal scores 142, 146, and 150, respectively.

Generally speaking, each recommendation within each set of recommendations 160 is an identifier (e.g., a unique string or integer) uniquely associated with a single meal-kit (i.e., each set of recommendations 160 may be a set of unique identifiers). Further, each set of recommendations 160 may be ordered or prioritized based on the corresponding meal scores 140.

### The Recommendation Engine 109

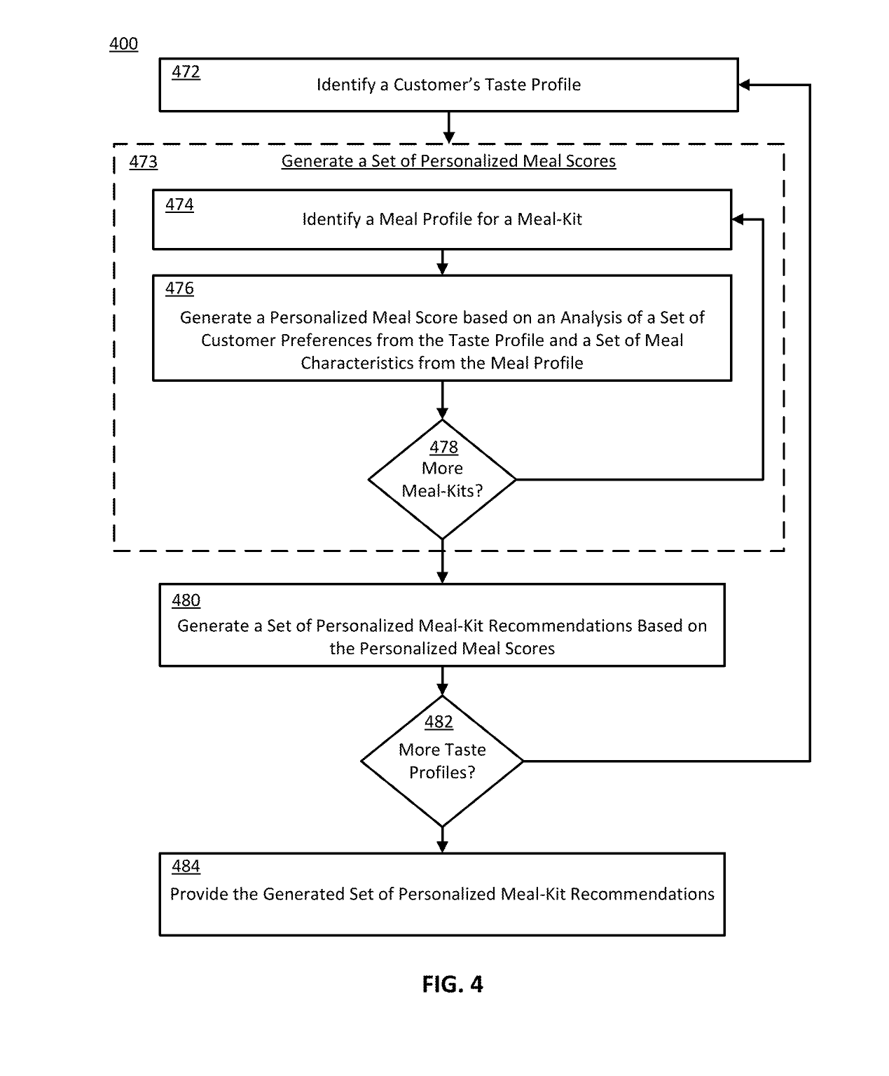

The recommendation engine 109 is an electronic device including a memory 109a, a processor 109b, an I/O interface 109c, and a communication interface 109d, each of which may be communicatively connected to a system bus (not shown). The memory 109a of the engine 109 includes a recommendation engine module 110, which is a set of machine readable instructions (e.g., a software module, application, or routine) that, when executed by the processor 109b, causes the engine 109 to generate and store the personalized meal scores 140 and the personalized meal-kit recommendations 160. The server 107 is configured to provide the personalized meal-kit recommendations 160 to the client devices 104 such that the client devices 104 receive sets of meal-kit recommendations that have been specifically tailored to the particular users of the client devices 104 based on each user's taste profile included in the taste profiles 124. An example technique for generating the personalized meal scores 140 and providing the meal-kit recommendations 160 is described in greater detail with respect to FIG. 4.

While FIG. 1A depicts a single server 107 and a single recommendation engine 109 distinct from the server 107, the system 100 may include multiple servers 107, and/or multiple recommendation engines 109. Further, a single device, such as the server 107, may implement both the server module 108 and the recommendation engine 110 to provide all functionality described herein as being provided by the server 107 and the recommendation engine 109.

Further, each of the databases 113-117 is an organized collection of data that may be stored and organized in any suitable manner. For example, the data described as being stored at any one or more of the databases 113-117 may be stored at any number of databases and any number of memory/storage devices. As an example, some or all of the data described as being stored at the databases 113-117 may be stored at the memory 107a, the memory 109a, a memory of one or more computers not explicitly shown in FIG. 1 (e.g., at an off-site data center), or some combination thereof.

### An Example Method of Recommending Meal-Kits

FIG. 4 is a flow chart of an example method 400 for providing personalized meal-kit recommendations to customers. Generally speaking, the system 100 implements the method 400 to provide personalized meal-kit recommendations to each of one or more customers. For each customer, the system 100 may implement the method 400 to determine which of a plurality of meal-kits best match a customer's preferences and to recommend the best matching meal-kits to the customer. The method 400 may be implemented, in whole or in part, by the system 100 (e.g., including the systems 101 and/or 103) shown in FIG. 1A. The method 400 may be saved to a memory as one or more instructions or routines.

At step 472, the recommendation engine 109 identifies a customer's taste profile 125 from the one or more taste profiles 124 stored at the database 115. The taste profile 125 may be identified in response to any of a number of triggers. For example, the trigger may be the customer initiating a shopping session. In some instances, the trigger is a regularly scheduled event. That is, the taste profiles 124 may be regularly updated on a schedule (e.g., weekly, biweekly, monthly, etc.). As another example, the trigger may be the creation of the taste profile 125 (e.g., because none of the meal profiles 128 have yet been evaluated with respect to the newly created taste profile 125) and/or the creation of one or more of the meal profiles 128 (e.g., because the new one or more meal profiles have not yet been evaluated with respect to the taste profile 125).

At step 473, the recommendation engine 109 generates a set of personalized meal scores 142 (stored at the database 115) for the customer uniquely associated with the taste profile 125. The set of personalized meal scores 142 is generated based on an analysis that includes comparing one or more (or all) of the meal profiles 128 to the taste profile 125. Step 473 includes sub-steps 474, 476, and 478.

At step 474, the recommendation engine 109 identifies, from the one or more meal profiles 128, a first meal profile 129. At step 476, the recommendation engine 109 generates a personalized meal score 143 for the pair (i.e., the customer corresponding to the identified taste profile 125 and the meal-kit corresponding to the meal profile 129). Generally speaking, the personalized meal score 143 is a score representing the extent to which the customer's preferences match the characteristics of the meal-kit corresponding to the meal profile 129. The personalized meal score 143 is generated based on an analysis of: (i) a set of customer preferences included in the taste profile 125 (e.g., represented by “customer preference variables” or “customer tags”); and (ii) a set of meal-kit traits included in the meal profile 129 (e.g., represented by “meal-kit descriptor variables” or “meal tags”). The personalized meal score 143 may be calculated according to any suitable scale (e.g., 0-5, 0-100, A-F, etc.).

At step 478, the recommendation engine 109 determines how many meal profiles 128 remain unscored with respect to the customer's taste profile 125. If unevaluated meal profiles remain, the recommendation engine 109 again implements step 474 to identify a second meal profile corresponding to a second meal-kit. The recommendation engine 109 then implements step 476, generating a second personalized meal score for the second meal profile and may store the second personalized meal score as one of the set of personalized meal scores 142 at the database 115. Finally, the recommendation engine again implements step 478. The recommendation engine 109 continues this iterative process of executing steps 474-478 until all desired meal profiles 128 have been scored with respect to the customer's taste profile 125. In some instances, the recommendation engine 109 may not score all available meal profiles. For example, the recommendation engine 109 may only score meal profiles scheduled to be available on a meal-kit menu at a particular time (e.g., only meal profiles for meals advertised on the next week's meal-kit menu), or may only score a subset of meal profiles manually selected by a user. In any event, after the recommendation engine 109 generates the set of personalized meal scores 142 for the meal profiles 128 and the taste profile 125, the recommendation engine 109 may implement step 480.

At step 480, the recommendation engine 109 generates a set of personalized meal-kit recommendations 162 based on the set of personalized meal scores 142. The personalized set of recommendations 162 may be a set of unique identifiers (e.g., unique strings or numbers), each identifying a particular meal-kit. The recommendations 162 may be ordered (e.g., according to the scores 142) or unordered, depending on the implementation. The recommendation engine 109 generates the set 162 by evaluating the personalized meal scores 142. For example, the recommendation engine 109 may identify the highest three scores from the scores 142 to include in the recommendations 162. The number of highest scores to be identified may be set via a variable, which may be any suitable value (e.g., one, three, five, etc.). As another example, the recommendation engine 109 may identify all scores from the meal scores 142 that are above a threshold value, which may be set by a user (e.g., based on the scale used for the scores 142).

At step 482, the recommendation engine 109 evaluates the taste profiles 124 and/or the meal profiles 128 to determine if additional taste profiles (other than the taste profile 125) should be analyzed and compared to the meal profiles 128.

If step 482 reveals that additional taste profiles should be evaluated with respect to the meal profiles 128, the recommendation engine 109 implements step 472 to identify a second taste profile for a second customer. The recommendation engine 109 then implements step 473 to generate: (i) a second set of personalized meal scores 146 corresponding to the second taste profile and to the meal profiles 128, and (ii) a second set of personalized meal-kit recommendations 164 corresponding to the second set of personalized meal scores 146. If a third taste profile needs to be evaluated, the recommendation engine 109 may identify a third taste profile and may generate: (i) a third set of personalized meal scores 150 corresponding to the third taste profile and to the meal profiles 128; and (ii) a third set of personalized meal-kit recommendations 166 corresponding to the third set of personalized meal scores 150. The recommendation engine 109 continues this iterative process of executing steps 472-482 until all desired meal profiles 128 have been scored with respect to all desired taste profiles 124.

At step 484, the server 107 and the one or more clients 104 provide one or more of the personalized meal-kit recommendations 160 to a customer or potential customer. To provide the recommendations to a user, the server 107 may populate a user's shopping cart with meal-kits identified in a corresponding set of personalized meal-kit recommendations and/or may customize the meal-kit menu transmitted to the client according to the set of meal-kit recommendations for the user (e.g., by arranging the order of meal-kits displayed on a meal-kit menu according to the set of meal-kit recommendations for the user, and/or by including explicit advertisements for the meal-kits identified by the set of meal-kit recommendations).

After the meal-kit menu(s) and/or shopping cart(s) have updated in view of the personalized meal-kit recommendations 160, the server 107 may transmit the updated meal-kit menu(s) and shopping cart statuses to the clients 104. For example, the shopping cart 149 may be uniquely associated with a customer using the client device 105 and having the taste profile 125. Accordingly, the server 107 may update the shopping cart 149 to include meal-kits corresponding to the meal-kit recommendations 162. The server 107 may be said to “auto-populate” the shopping cart 140 with suggested meal-kits (e.g., at or near the beginning of a user's shopping session, when the shopping cart 149 is empty). Generally speaking, this auto-population will not override items in the shopping cart 149 that have been added by a user. For each of the other clients 104, the server may similarly update other shopping carts 148 corresponding to the users of the other clients 104 based on the personalized meal scores (e.g., 164 or 166) for each of the users.

Further, the server 107 may customize the meal-kit menu 145 before transmitting it to the client 105. For example, the server 107 may arrange the order of meal-kit cards (each advertising a particular meal-kit) based on the recommendations 162 so that the recommended meal-kits are displayed higher on the menu 145 than meal-kit cards for meal-kits that did not score as well. The server 107 may also include elements in the menu 145 for specifically advertising the recommended meal-kits (e.g., an element listing recommended meal-kits). For each of the other clients 104, the server may similarly customize the meal-kit menu 145 based on the personalized meal scores (e.g., 164 or 166) corresponding to the users of the other clients 104.

It will be appreciated that the steps in the method 400 may be implemented in an order different than that shown in FIG. 4. For example, step 484 may be implemented before step 482. Further, it will be appreciated that the method 400 need not be implemented in it's entirety at a single time. For example, gaps in time may exists between when different taste profiles are evaluated.

### Example Method of Calculating a Personalized Meal-Score

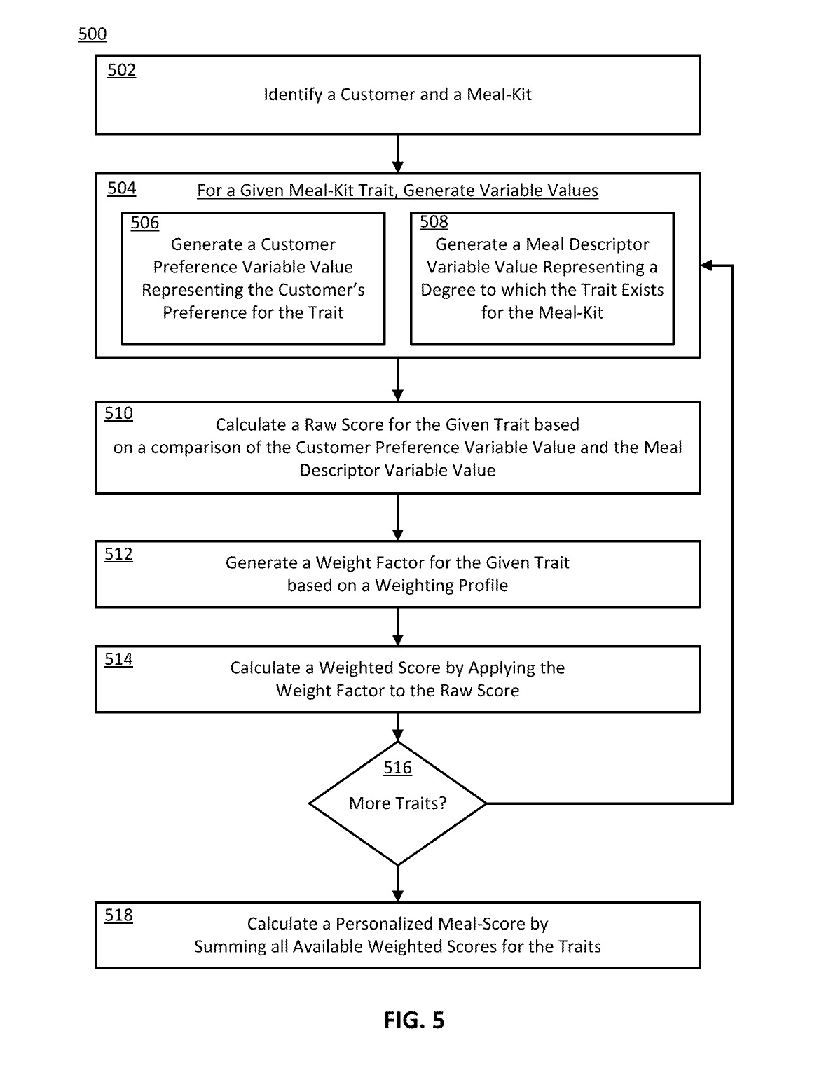

FIG. 5 is a flow chart of a method 500 of calculating a personalized meal-score for a particular customer and a particular meal-kit. The method 500 may be implemented, in whole or in part, by the system 100, and, in particular, by the recommendation engine 109 shown in FIG. 1A. The method 500 includes steps 502-518 and may be saved to a memory as one or more instructions or routines.

At step 502, the recommendation engine 109 identifies a customer and a meal-kit. In particular, the recommendation engine 109 may identify a taste profile for the customer (e.g., the taste profile 125) and a meal profile for the meal-kit (e.g., the meal profile 129).

At step 504, which includes substeps 506 and 508, the recommendation engine 109 generates variable values corresponding to a given meal-kit trait (e.g., the meal-kit trait 301 shown in FIG. 3).

In particular, at substep 506, the recommendation engine 109 generates a customer preference variable value (e.g., variable 311 in the taste profile 125) representing the customer's preference for the given trait (e.g., the trait 301—“Spicy”). As already noted, the customer preference variable may be assigned a value according to any desired scale (e.g., binary or non-binary). In some instances, the customer preference variable value is represented by a “customer tag,” the existence of which in a taste profile (e.g., the profile 125) indicates the associated customer has a preference for the given trait. The customer preference variable value may be set by a customer during a taste profile setup procedure. For example, the customer may be prompted via the display 105f of the client 105 to provide a value for the customer preference variable (e.g., by selecting a displayed tag or by entering a number, within a provided scale, indicating the customer's preference). Further, as described with reference to the taste profiles 124 shown in FIG. 1A, the recommendation engine 109 may automatically set the customer preference variable value based on an analysis of the customer's purchase history.

At substep 508, the recommendation engine 109 generates a meal-kit descriptor variable value (e.g., variable 321 in the meal profile 129) representing the degree to which the meal-kit possesses the given trait (e.g., the trait 301—“Spicy”). Like the customer preference variable, the meal-kit descriptor variable may be assigned a value according to any desired scale. In some instances, the meal-kit descriptor variable value is represented by a “meal tag,” the existence of which in a meal profile (e.g., the profile 129) indicates the associated meal-kit possesses the given trait. As described with reference to the meal profiles 128 shown in FIG. 1A, the meal-kit descriptor variable value may be set automatically (e.g., by the recommendation engine 109 based on customer feedback regarding the meal and/or relevant ingredients) or manually (e.g., by a chef, a designer, or some other personnel).

At step 510, the recommendation engine 109 calculates a raw score (e.g., the raw score 351 shown in FIG. 3) for the given trait based on a comparison of the customer preference variable value (e.g., variable 311) and the meal descriptor variable value (e.g., variable 321). The raw score may be set according to any desirable scale (e.g., 0/1, 1-3, 1-5, etc.), and may or may not correspond to the scale used for the variables, depending on the implementation. For example, the variables may be set according to a non-binary scale (e.g., 1-5) and the raw score may be set according to a binary scale to indicate that a match either exists or does not exist. For example, the raw score may be set to “1” to indicate a match only when the variables have identical values, or only when the variables have values within a threshold range (e.g., “1”) of each other.

At step 514, the recommendation engine 109 calculates a weighted score (e.g., the weighted score 361 shown in FIG. 3) for the given trait by applying the weight factor (e.g., weight factor 331) to the raw score (e.g., raw score 351).

At step 516, the recommendation engine 109 determines whether other traits remain unscored with respect to the customer and the meal-kit. For example, the taste profile 125 and the meal profile 129 may need to be evaluated with respect to the traits 303-309 shown in FIG. 3. When further evaluation is needed with respect to other traits, the recommendation engine 109 repeats steps 504-514 for each additional trait.

At step 518, the recommendation engine 109 calculates a personalized meal score (e.g., the personalized meal score 143 shown in FIG. 1 and the total weighted score 394 shown in FIG. 3) by summing all available weighted scores for the traits (e.g., weighted scores 361-369). In some instances, the personalized meal-score may be calculated by summing all available raw scores for the traits (e.g., raw scores 351-359). After the personalized meal score is calculated, the recommendation engine 109 may evaluate other meal profiles with respect to the taste profile (e.g., see step 478 in FIG. 4).

It will be appreciated that the steps in the method 500 may be implemented in an order different than that shown in FIG. 5. For example, steps 510 and 512 may be implemented concurrently, or step 512 may be implemented before step 510. As another example, one or both of the steps 506 and 508 may be implemented before step 502.

### ADDITIONAL CONSIDERATIONS

Although this detailed description contemplates various embodiments, it should be understood that the legal scope of any claimed system or method is defined by the words of the claims set forth at the end of this patent. This detailed description is to be construed as exemplary only and does not describe every possible embodiment, as describing every possible embodiment would be impractical, if not impossible.

Throughout this specification, plural instances may implement components, operations, or structures described as a single instance. Although individual operations of one or more methods are illustrated and described as separate operations, one or more of the individual operations may be performed concurrently in certain embodiments.

As used herein, any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This description, and the claims that follow, should be read to include one or at least one. The singular also includes the plural unless it is obvious that it is meant otherwise.

Throughout this specification, some of the following terms are used.

Bus. Generally speaking, a processor or a particular system or subsystem may communicate with other components of the system or subsystem via one or more communication links. When communicating with components in a shared housing, for example, the processor may be communicatively connected to components by a system bus. For example, each of the devices 104, 107, and 109 may have a system bus utilized by the respective processors of those devices to communicate with the other components of the device. Unless stated otherwise, as used herein the phrase “system bus” and the term “bus” refer to: a data bus (for carrying data), an address bus (for determining where the data should be sent), a control bus (for determining the operation to execute), or some combination thereof. Depending on the context, “system bus” or “bus” may refer to any of several types of bus structures including a memory bus or memory controller, a peripheral bus, or a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Communication Interface. Some of the described devices and/or systems include a “communication interface” (sometimes referred to as a “network interface”). For example, the client 105 includes a communication interface 105d, the server 107 includes a communication interface 107d, and the recommendation engine 109 includes a communication interface 109d. A communication interface of a system enables the system (e.g., the devices 105-109) to send information or data to other system and/or receive information/data from other systems. In some instances, a communication interface of a system may be utilized to establish a direct connection to another system. In some instances, a communication interface of a system enables the system to connect to a network (via a link).

To illustrate, each of the described communication interfaces may include circuitry for permitting wireless communication (e.g., short-range and/or long-range communication) or wired communication with one or more other devices or systems using any suitable communications protocol. For example, each of the described communication interfaces may support Wi-Fi (e.g., an 802.11 protocol), Ethernet, Bluetooth, high frequency systems (e.g., 900 MHZ, 2.4 GHZ, and 5.6 GHZ communication systems), infrared, transmission control protocol/internet protocol (“TCP/1P”) (e.g., any of the protocols used in each of the TCP/IP layers), hypertext transfer protocol (“HTTP”), BitTorrent, file transfer protocol (“FTP”), real-time transport protocol (“RTP”), real-time streaming protocol (“RTSP”), secure shell protocol (“SSH”), any other communications protocol, or any combination thereof. Depending on the embodiment, each of the described communication interfaces may also include circuitry that enables electrical or optical coupling to another device (e.g., via a coax cable or fiber optic cable), enabling communication with that other device.

Communication Link. A “communication link” or “link” is a pathway or medium connecting two or more nodes. A link may be a physical link and/or a logical link. A physical link is the interface and/or medium(s) over which information is transferred, and may be wired or wireless in nature. Examples of physicals links may include a cable with a conductor for transmission of electrical energy, a fiber optic connection for transmission of light, and/or a wireless electromagnetic signal that carries information via changes made to one or more properties of an electromagnetic wave(s).

A logical link between two or more nodes represents an abstraction of the underlying physical links and/or intermediary nodes connecting the two or more nodes. For example, two or more nodes may be logically coupled via a logical link. The logical link may be established via any combination of physical links and intermediary nodes (e.g., routers, switches, or other networking equipment).

Memory and Computer-Readable Media. Generally speaking, as used herein the phrase “memory” or “memory device” refers to a system or device including computer-readable media (“CRM”). “CRM” refers to a medium or media accessible by the relevant computing system for placing, keeping, and/or retrieving information (e.g., data, computer-readable instructions, program modules, applications, routines, etc.). Note, “CRM” refers to media that is non-transitory in nature, and does not refer to disembodied transitory signals, such as radio waves.

The CRMs of the described memories may be implemented in any technology, device, or group of devices included in the relevant computing system or in communication with the relevant computing system. The CRM may include volatile and/or nonvolatile media, and removable and/or non-removable media. The CRM may include, but is not limited to, RAM, ROM, EEPROM, flash memory, or other memory technology, CD-ROM, digital versatile disks (DVD) or other optical disk storage, magnetic cassettes, magnetic tape, magnetic disk storage or other magnetic storage devices, or any other medium which can be used to store information and which can be accessed by the computing system. The CRM may be communicatively coupled to a system bus, enabling communication between the CRM and other systems or components coupled to the system bus. In some implementations, the CRM may be coupled to the system bus via a memory interface (e.g., a memory controller). A memory interface is circuitry that manages the flow of data between the CRM and the system bus.

Network. As used herein and unless otherwise specified, when used in the context of system(s) or device(s) that communicate information or data, the term “network” refers to a collection of nodes (e.g., devices or systems capable of sending, receiving and/or forwarding information) and links which are connected to enable telecommunication between the nodes.

Processor. The various operations of example methods described herein may be performed, at least partially, by one or more processors. For example, the system 100 includes process 105b, 107b, and 109b. Generally speaking, the terms “processor” and “microprocessor” are used interchangeably, each referring to a computer processor configured to fetch and execute instructions stored to memory. By executing these instructions, the processor(s) can carry out various operations or functions defined by the instructions. The processor(s) may be temporarily configured (e.g., by instructions or software) or permanently configured to perform the relevant operations or functions (e.g., a processor for an Application Specific Integrated Circuit, or ASIC), depending on the embodiment. A processor may be part of a chipset, which may also include, for example, a memory controller and/or an I/O controller. A chipset is a collection of electronic components in an integrated circuit that is typically configured to provide I/O and memory management functions as well as a plurality of general purpose and/or special purpose registers, timers, etc. Generally speaking, one or more of the described processors may be communicatively coupled to other components (such as memory devices and I/O devices) via a system bus.

The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

Words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

What is claimed is:

1. A method for recommending meal-kits, the method comprising:
displaying a set of meal-kit traits via a graphical user interface (GUI) presented at a display;
in response to detecting a first actuation of a user input device representing user input corresponding to the displayed set of meal-kit traits, setting a taste profile for a user by setting values for each of a set of preference variables representing the user's preferences regarding the set of meal-kit traits;
in response to detecting a second actuation of the user input device representing user input corresponding to a request to initiate a shopping session, displaying via the GUI one or more meal-kit recommendations selected based on a set of personalized meal scores that have been calculated by analyzing a plurality of factors, the plurality of factors including:
(i) the taste profile; and
(ii) a plurality of meal profiles each representing one of a plurality of meal-kits, wherein the plurality of meal profiles includes: (a) a first meal profile representing a first meal-kit, wherein the first meal profile includes a first set of meal-kit variables and wherein each meal-kit variable in the first set of meal-kit variables has a value quantifying a degree to which the first meal-kit possesses one meal-kit trait in the set of meal-kit traits; and (b) a second meal profile representing a second meal-kit, wherein the second meal profile includes a second set of meal-kit variables and wherein each of the meal-kit variables in the second set of meal-kit variables has a value quantifying a degree to which the second meal-kit possesses one of the meal-kit traits in the set of meal-kit traits.

2. The method of claim 1, wherein displaying via the GUI the one or more meal-kit recommendations comprises: displaying a meal-kit menu that includes one or more meal-kits arranged according to an order determined by the set of personalized meal scores.

3. The method of claim 1, wherein displaying via the GUI the one or more meal-kit recommendations comprises: automatically populating a shopping cart, displayed via the GUI, with one or more meal-kits selected according to the set of personalized meal scores.

4. The method of claim 1, wherein analyzing the plurality of factors comprises: (i) calculating a first set of raw scores based on a comparison between the taste profile and the first meal profile, wherein each raw score within the first set corresponds to a meal-kit trait from the set of meal-kit traits; and (ii) calculating a second set of raw scores based on a comparison between the taste profile and the second meal profile, wherein each raw score within the second set corresponds to a meal-kit trait from the set of meal-kit traits.

5. The method of claim 4, wherein the set of personalized meal scores includes a first personalized meal score calculated by totaling the first set of raw scores and a second personalized meal score calculated by totaling the second set of raw scores.

6. The method of claim 4, wherein analyzing the plurality of factors further comprises:
identifying a set of weight factors, wherein each weight factor in the set represents a relative importance of a meal-kit trait from the set of meal-kit traits;
applying the set of weight factors to the first set of raw scores to generate a first set of weighted scores; and
applying the set of weight factors to the second set of raw scores to generate a second set of weighted scores;
wherein the set of personalized meal scores includes a first personalized meal score calculated by totaling the first set of weighted scores and a second personalized meal score calculated by totaling the second set of weighted scores.

7. The method of claim 6, wherein the set of weight factors represents the relative importance of the meal-kit traits to the user.

8. A method for automatically recommending meal-kits, the method comprising:
(A) generating, by one or more servers, a taste profile for a user based on first data received at the one or more servers, wherein the first data represents a set of preferences that has been selected via a graphical user interface (GUI);
(B) calculating, by the one or more servers, a set of personalized meal scores tailored to the user's taste profile, wherein the calculating includes:
(i) identifying a plurality of meal profiles each representing a set of meal-kit traits possessed by one of a plurality of meal-kits; and
(ii) for each of the plurality of meal profiles, calculating a personalized meal score based on a comparison to the user's taste profile;
(C) when the one or more servers receive from a client device a request to initiate a shopping session, detecting a user identifier associated with the request and identifying the set of personalized meal scores tailored to the user's taste profile based on the user identifier; and
(D) in response to receiving the request, transmitting to the client device one or more meal-kit recommendations selected based on the set of personalized meal scores tailored to the user's taste profile.

9. The method of claim 8, wherein transmitting to the client device the one or more meal-kit recommendations comprises: transmitting a meal-kit menu that displays one or more meal-kits arranged according to an order determined by the set of personalized meal scores.

10. The method of claim 8, wherein transmitting to the client device the one or more meal-kit recommendations comprises: automatically populating a shopping cart with one or more meal-kits selected according to the set of personalized meal scores.

11. The method of claim 8, wherein calculating the set of personalized meal scores comprises:
calculating a plurality of sets of raw scores including a set of raw scores for each of the meal profiles, wherein each set of raw scores is calculated based on a comparison between the taste profile and one of the plurality of meal profiles, wherein each raw score within each set of raw scores corresponds to a particular meal-kit trait.

12. The method of claim 11, wherein each personalized meal score is the sum of a set of raw scores selected from the plurality of sets of raw scores.

13. The method of claim 11, wherein calculating the set of personalized meal scores further comprises:
identifying a set of weight factors, wherein each weight factor in the set represents a relative importance of a meal-kit trait from the set of meal-kit traits; and
applying the set of weight factors to each set of raw scores to generate a plurality of sets of weighted scores; and
wherein each personalized meal score in the set of personalized meal scores is calculated by totaling one of the sets of weighted scores.

14. The method of claim 13, wherein each weight factor in the set of weight factors represents a relative importance of a meal-kit trait to the user.

15. A system including:
a client device that displays a set of meal-kit traits via a graphical user interface (GUI) and responds to detecting a selection of a user's preferences regarding the meal-kit traits by transmitting the user's preferences;
one or more servers that:
(i) receive the user's preferences and generate a taste profile for the user, wherein the taste profile includes a set of preference variables representing the user's preferences;
(ii) calculate a set of personalized meal scores tailored to the user's taste profile, wherein each personalized meal score in the set corresponds to one of a plurality of meal profiles representing a plurality of meal-kits;
(iii) respond to a request to initiate a shopping session by: (a) detecting a user identifier associated with the request; (b) identifying the set of personalized meal scores tailored to the user's taste profile based on the user identifier; and (c) transmitting one or more meal-kit recommendations selected based on the set of personalized meal scores tailored to the user's taste profile;
wherein the client device responds to receiving the one or more meal-kit recommendations by displaying the one or more meal-kit recommendations.

16. The system of claim 15, wherein displaying the one or more meal-kit recommendations comprises: displaying a meal-kit menu that includes one or more meal-kits arranged according to an order determined by the set of personalized meal scores.

17. The system of claim 15, wherein displaying the one or more meal-kit recommendations comprises: automatically populating a shopping cart, displayed by the client device, with one or more meal-kits selected according to the set of personalized meal scores.

18. The system of claim 15, wherein the one or more servers calculate the set of personalized meal scores by:
calculating a plurality of sets of raw scores including a set of raw scores for each of the meal profiles, wherein each set of raw scores is calculated based on a comparison between the taste profile and a one of the plurality of meal profiles, wherein each raw score within each set of raw scores corresponds to a particular meal-kit trait.

19. The system of claim 18, wherein each personalized meal score is the sum of a set of raw scores selected from the plurality of sets of raw scores.

20. The system of claim 18, wherein the one or more servers calculate the set of personalized meal scores by:
identifying a set of weight factors, wherein each weight factor represents a relative importance of a meal-kit trait from the set of meal-kit traits; and
applying the set of weight factors to each set of raw scores to generate a plurality of sets of weighted scores; and
wherein each personalized meal score in the set of personalized meal scores is calculated by totaling one of the sets of weighted scores.

21. The system of claim 20, wherein the set of weight factors represents the relative importance of the meal-kit traits to the user.
